(19) United States
(12) Patent Application Publication
(10) Pub. No.: US 2014/0272356 A1
(43) Pub. Date: Sep. 18, 2014

(54) ELASTOMERIC MATERIALS COMPRISING BIODEGRADABLE AND/OR SUSTAINABLE POLYMERIC COMPONENTS

(71) Applicant: CLOPAY PLASTIC PRODUCTS COMPANY, INC., Mason, OH (US)

(72) Inventors: Frank He, Mason, OH (US); Linda Lin, Mason, OH (US); Leopoldo V. Cancio, Vero Beach, FL (US); Pai-Chuan Wu, Cincinnati, OH (US)

(73) Assignee: CLOPAY PLASTIC PRODUCTS COMPANY, INC., Mason, OH (US)

(21) Appl. No.: 13/796,349

(22) Filed: Mar. 12, 2013

(51) Int. Cl. C08L 67/04; C08L 23/02

(52) U.S. Cl. CPC C08L 67/04; C08L 23/02
USPC 428/219; 525/190; 442/395

(57) ABSTRACT

Elastomeric films and laminates comprising one or more biodegradable and/or sustainable polymers are disclosed. The biodegradable and/or sustainable polymers can be added to the elastomeric film at concentrations up to about 40%, while the film still retains acceptable elastomeric properties. Methods of making elastomeric films or laminates comprising one or more biodegradable and/or sustainable polymers are also disclosed.

### BACKGROUND OF THE INVENTION

Because of environmental concerns, there is growing interest in biodegradable and/or sustainable polymers in products. Consumers like the convenience of plastics, but worry about expanding landfills that contain materials that don't degrade. Petroleum resources are diminishing, and there is a growing desire to reduce human dependence on oil. For these reasons, polymers that are biodegradable, sustainable, or both are becoming more popular in consumer products.

Biodegradable polymers tend to be stiff and brittle in character. For many years, researchers have studied additives such as plasticizers and impact modifiers to make biodegradable polymers softer, less brittle, and easier to extrude or mold into useful products. Biodegradable polymers have also tended to be very expensive, although the growing demand for these materials is bringing down the price.

Sustainable polymers, which are made from renewable resources such as plants, may or may not be biodegradable. Many biodegradable polymers are made from renewable resources, of course. Another area of research has been to develop ways to use plant-based raw materials to synthesize common polymers made from petroleum, in particular polyethylene (PE). Replacing petroleum-based PE with plant-based PE would both reduce our dependence on oil and remove carbon dioxide from the air, thereby counteracting global warming.

The development of biodegradable and/or sustainable (Bio-Sus) elastomeric materials has lagged, however. Natural rubber is sustainable and biodegradable if not cross-linked. Most modern elastomeric materials are neither biodegradable nor sustainable, though, and there has been little research in developing elastomeric Bio-Sus materials.

Hence, there is a need for developing elastomeric materials that contain biodegradable and/or sustainable components.

### SUMMARY OF THE INVENTION

Some embodiments of the present invention relate to elastomeric films comprising one or more Bio-Sus polymers.

Other embodiments of the present invention relate to methods of making elastomeric films comprising one or more Bio-Sus polymers.

Other embodiments of the present invention relate to laminates comprising a web material, such as a nonwoven fabric, bonded to an elastomeric film comprising one or more Bio-Sus polymers.

Other embodiments of the present invention relate to methods of making laminates comprising a web material, such as a nonwoven fabric, bonded to an elastomeric film comprising one or more Bio-Sus polymers.

Other embodiments of the present invention relate to elastomeric laminates comprising a web material, such as a nonwoven fabric, bonded to an elastomeric film comprising one or more Bio-Sus polymers, which are then activated to render the laminates elastomeric.

Other embodiments of the present invention relate to methods of making elastomeric laminates comprising a web material, such as a nonwoven fabric, bonded to an elastomeric film comprising one or more Bio-Sus polymers, which are then activated to render the laminate elastomeric.

### BRIEF DESCRIPTION OF THE DRAWINGS

The invention will be more fully understood in view of the drawings, in which:

FIG. 1 is a graph showing the tensile properties of materials of the present invention in the machine direction (MD);

FIG. 2 is a graph showing the tensile properties of materials of the present invention in the cross direction (CD).

### DETAILED DESCRIPTION

For the purpose of this disclosure, the following terms are defined:

“Biodegradable” refers to materials that degrade by biological processes resulting from the action of naturally-occurring micro-organisms such as bacteria, fungi and algae.

“Sustainable” refers to useful materials that can be economically produced from renewable resources such as plants.

“Bio-Sus” refers to polymers that are biodegradable, sustainable, or both.

“Film” refers to material in a sheet-like form where the dimensions of the material in the x (length) and y (width) directions are substantially larger than the dimension in the z (thickness) direction.

“Basis weight” is an industry standard term that quantifies the thickness or unit mass of a film or laminate product. The basis weight is the mass per planar area of the sheet-like material. Basis weight is commonly stated in units of grams per square meter (gsm) or ounces per square yard (osy).

“Coextrusion” refers to a process of making multilayer polymer films. When a multilayer polymer film is made by a coextrusion process, each polymer or polymer blend comprising a layer of the film is melted by itself. The molten polymers may be layered inside the extrusion die, and the layers of molten polymer films are extruded from the die essentially simultaneously. In coextruded polymer films, the individual layers of the film are bonded together but remain essentially unmixed and distinct as layers within the film. This is contrasted with blended multicomponent films, where the polymer components are mixed to make an essentially homogeneous blend or heterogeneous mixture of polymers that are extruded in a single layer.

“Elastomeric” or “elastomer” refer to materials which can be stretched to at least about 150% or more of their original dimension, and which then recover to no more than about 120% of their original dimension in the direction of the applied stretching force. For example, an elastomeric film that is 10 cm long should stretch to at least about 15 cm under a suitable stretching force, and then retract to no more than about 12 cm when the stretching force is removed. Elastomeric materials are both stretchable and recoverable.

“Stretchable” and “recoverable” are descriptive terms used to describe the elastomeric properties of a material. “Stretchable” means that the material can be extended by a pulling force to a specified dimension significantly greater than its initial dimension without breaking. For example, a material that is 10 cm long that can be extended to about 13 cm long without breaking under a pulling force could be described as stretchable. “Recoverable” means that a material which is extended by a pulling force to a certain dimension significantly greater than its initial dimension without breaking will return to its initial dimension or a specified dimension that is adequately close to the initial dimension when the pulling force is released. For example, a material that is 10 cm long that can be extended to about 13 cm long without breaking under a pulling force, and which returns to about 10 cm long or to a specified length that is adequately close to 10 cm could be described as recoverable.

“Extensible” refers to materials that can be stretched at least about 130% of their original dimension without breaking, but which either do not recover significantly or recover to greater than about 120% of their original dimension and therefore are not elastomeric as defined above. For example, an extensible film that is 10 cm long should stretch to at least about 13 cm under a stretching force, then either remain about 13 cm long or recover to a length more than about 12 cm when the stretching force is removed. Extensible materials are stretchable, but not recoverable.

“Permanent set” is the permanent deformation of a material after removal of an applied load. In the case of elastomeric films, permanent set is the increase in length of a sample of a film after the film has been stretched to a specified length and then allowed to relax. Permanent set is typically expressed as a percent increase relative to the original size. For example, if a 10 cm piece of elastomeric film is stretched to 20 cm, then allowed to relax, and the resulting relaxed film is 11.5 cm in length, the permanent set of the film is 15%.

“Activation” or “activating” refers to a process by which an elastomeric film or material is rendered easy to stretch. Most often, activation is a physical treatment, modification or deformation of the elastomeric film. Stretching a film for the first time is one means of activating the film. An elastomeric material that has undergone activation is called “activated.”

“Tensile properties” are properties measured when a material is subjected to stretching forces, and also the properties measured when the stretching forces are removed. Example tensile properties include but are not limited to tensile strength at break, percent elongation to break, modulus of elasticity, toughness or tensile energy to break, permanent set, tensile load at specified elongations, etc. Tensile properties of polymer films can be determined by standard test methods such as ASTM D882, “Standard Test Method for Tensile Properties of Thin Plastic Sheeting.”

The elastomeric film of the invention comprises any extrudable elastomeric polymer. Examples of such elastomeric polymers include block copolymers of vinyl arylene and conjugated diene monomers, natural rubbers, polyurethane rubbers, polyester rubbers, elastomeric polyolefins and polyolefin blends, elastomeric polyamides, or the like. The elastomeric film may also comprise a blend of two or more elastomeric polymers of the types previously described. Preferred elastomeric polymers are the block copolymers of vinyl arylene and conjugated diene monomers, such as AB, ABA, ABC, or ABCA block copolymers where the A segments comprise arylenes such as polystyrene and the B and C segments comprise dienes such as butadiene, isoprene, or ethylene butadiene. These block copolymers are readily available from polymer manufacturers such as KRATON® or Dexco™. Other preferred elastomeric polymers are olefin-based elastomeric polymers. Examples of olefin-based elastomeric polymers are olefin block copolymers (OBCs) which are elastomeric copolymers of polyethylene, sold under the trade name INFUSE™ by The Dow Chemical Company of Midland, Mich. (e.g., INFUSE™ 9107). Other examples of olefin-based elastomeric polymers are copolymers of polypropylene and polyethylene, sold under the trade name VISTAMAXX® by ExxonMobil Chemical Company of Houston, Tex. (e.g., VISTAMAXX® 6102).

The elastomeric film of the present invention also comprises a Bio-Sus polymeric material. Examples of biodegradable polymers that are also biosustainable include aliphatic polyesters, such as polylactic acid (PLA), and polycaprolactone (PCL); polyhydroxyalkanoates (PHAs), including polyhydroxybutyrates (PHBs), polyhydroxyhexanoates, and polyhydroxyoctanoate; polyhydroxyvalerates (PHVs) and copolymers thereof; and thermoplastic starch (TPS). Biodegradable polymers are available from a variety of suppliers. For instance, PLA is sold under the trade name INGEO® by NatureWorks LLC, Minnetonka, Minn.; PCL is sold under the trade name CAPA® by Perstorp, Toledo, Ohio; TPS is sold under the trade name Terraloy™ by Teknor Apex, Pawtucket, R.I.; and biodegradable aliphatic-aromatic polyesters are sold under the trade name Hytrel® by DuPont, Wilmington, Del., or under the trade name Ecoflex® by BASF, Florham Park, N.J. Examples of sustainable polymers include polyolefins and polyesters made from plant- or bacteria-based sources. Sustainable polyethylene can be purchased from Braskem, São Paulo, Brazil; sustainable TPS masterbatch materials can be purchased under the trade name Cereplast Sustainables® or Cereplast Compostables® from Cereplast Inc., Segunda, Calif.; and sustainable polyesters are sold under the trade name Nodax™ by Meredian Inc., Bainbridge, Ga., or under the trade name Mirel® by Metabolix, Lowell, Mass.

The inventors have found that Bio-Sus polymers can be blended with elastomeric polymers at concentrations of 5% up to about 40%, such that the films made from the blend retain acceptable elastomeric properties. This is quite unexpected, particularly for biodegradable polymers which tend to be inherently stiff and brittle. The polymer film blend may contain up to about 40% Bio-Sus polymer, preferably 5% up to about 38% Bio-Sus polymer, more preferably 10% up to about 35% Bio-Sus polymer, more preferably up to about 33% Bio-Sus polymer, more preferably 15% up to about 30% Bio-Sus polymer, more preferably up to about 28% Bio-Sus polymer, more preferably up to about 25% Bio-Sus polymer, more preferably up to about 20% Bio-Sus polymer.

It may be necessary to include a compatibilizer in the elastomeric film of the present invention, to improve the blending of the elastomeric polymer with the Bio-Sus polymer. Typical compatibilizers include polymeric compounds such as polyesters, poly(alkyl methyl acrylates), poly (alkyl acrylates), polyvinyl acetate, polystyrene, and copolymers or blends of these. A preferred compatibilizer is poly(ethylene methacrylate) (EMA). The compatibilizer can be added to the blend at concentrations from about 1-20%, more preferably from about 3-18%, more preferably from about 5-15%, more preferably from 8-15%, more preferably from 10-15%.

To form the film of the present invention, the components are meltblended and processed into a film. The elastomeric film of the present invention may include other components to modify the film properties, aid in the processing of the film, or modify the appearance of the film. For example, viscosity-reducing polymers and plasticizers may be added as processing aids. Other additives such as pigments, dyes, antioxidants, antistatic agents, slip agents, foaming agents, heat and/or light stabilizers, and inorganic and/or organic fillers may be added.

Any film-forming process can prepare the elastomeric film. Preferably, an extrusion process, such as cast extrusion or blown-film extrusion forms the film. Such processes are well known. The elastomeric film may also be in the form of a multilayer film. Coextrusion of multilayer films by cast or blown processes are also well known. The film can have a basis weight of about 5 gsm to about 150 gsm, preferably about 15 gsm to about 100 gsm, more preferably about 25 gsm to about 80 gsm, more preferably about 30 gsm to about 80 gsm.

The elastomeric film of this invention may be a multilayer film. The inventive elastomeric film may be an AB, ABA, ABC, ABCBA, or any other such combination of multiple layers. Each layer of a multilayer elastomeric film may comprise the same or different elastomeric polymers.

Specifically, elastomeric films may be an ABA structure, where the B layer comprises an elastomeric polymer and the A layers comprise an extensible polymer such as a polyolefin. In this structure, the B layer is called the ‘core’ layer and the A layers, which are frequently much thinner than the B layer, are called the ‘skin’ layers. One purpose of the skin layers in this construction is to prevent the elastomeric film from sticking to itself, also known as ‘blocking,’ when the film is wound into a roll. Suitable nonblocking polymers for these skins include polyolefins such as polyethylene or polypropylene.

Such a laminate includes one or more substrate layers and the elastomeric film (e.g., monolayer or multilayer film). The substrate layer may be an extensible material including but not limited to another polymer film, fabric, nonwoven fabric, woven fabric, knitted fabric, scrim, or netting. The elastomeric film can be bonded to substrate layers on one or both sides.

When two or more substrate layers are used to make the laminate, the substrate layers can be the same or different extensible material. The composition of the substrate layers can be the same or different, even when the same extensible material is used (e.g., two nonwoven layers where one nonwoven layer is made from polyolefin and the other nonwoven layer is made from polyester).

The substrate layer (e.g., nonwoven fabric) can have a basis weight of about 3 gsm to about 200 gsm, preferably about 3 gsm to about 75 gsm, more preferably about 5 gsm to about 50 gsm. If two substrate layers are used, one layer can have a basis weight that is the same or different from the other.

In some embodiments, the substrate layer is a nonwoven fabric. For example, the substrate layer can be spunbond nonwoven webs, carded nonwoven webs (e.g., thermally bonded, adhesively bonded, or spunlaced), meltblown nonwoven webs, spunlaced nonwoven webs, spunbond meltblown spunbond nonwoven webs, spunbond meltblown meltblown spunbond nonwoven webs, unbonded nonwoven webs, electrospun nonwoven webs, flashspun nonwoven webs (TYVEK® by DuPont), or combinations thereof. These fabrics can comprise fibers of polyolefins such as polypropylene or polyethylene, polyesters, polyamides, polyurethanes, elastomers, rayon, cellulose, copolymers thereof, or blends thereof or mixtures thereof. The nonwoven fabrics can also comprise fibers that are homogenous structures or comprise bicomponent structures such as sheath/core, side-by-side, islands-in-the-sea, and other bicomponent configurations. For a detailed description of some nonwovens, see “Nonwoven Fabric Primer and Reference Sampler” by E. A. Vaughn, Association of the Nonwoven Fabrics Industry, 3d Edition (1992). Such nonwoven fabrics can have a basis weight of at least about 3 gsm, at least about 5 gsm, at least about 10 gsm, at least about 15 gsm, at least about 20 gsm, at least about 25 gsm, at least about 30 gsm, or at least about 35 gsm.

The nonwoven fabrics can include fibers or can be made from fibers that have a cross section perpendicular to the fiber longitudinal axis that is substantially non-circular. Substantially non-circular means that the ratio of the longest axis of the cross section to the shortest axis of the cross section is at least about 1.1. The shape of the cross section perpendicular to the fiber longitudinal axis of the substantially non-circular fibers can be rectangular (which are also referred to as “flat” fibers), oblong (e.g., oval), trilobal, or multilobal in the cross section. These substantially non-circular fibers can provide more surface area to bond to the elastomeric film than nonwoven fabrics with fibers that are circular in cross section. Such an increase in surface area can increase the bond strength between the elastomeric film and fibers.

Additional processing steps such as activating, aperturing, printing, slitting, laminating additional layers, and other such processes can be added to the manufacturing of the inventive elastomeric film or laminate.

As one example of additional processing, the film or laminate can be activated by stretching. Machine-direction orientation (MDO) can be used to activate films or laminates in the machine direction, while tentering can activate films or laminates in the cross direction. Incremental stretching can be used to activate films or laminates in the machine direction, cross direction, at an angle, or any combination thereof. In some embodiments, the depth of engagement used for incremental stretching is about 0.050 inches, about 0.1 inches, or about 0.25 inches. The depth of engagement can be, for example, at least about 0.050 inches, at least about 0.080 inches, at least about 0.100 inches, at least about 0.120 inches, at least about 0.150 inches, at least about 0.160 inches, at least about 0.180 inches or at least about 0.200 inches.

Laminates of elastomeric films and nonwoven fabrics are particularly suited to activation by incremental stretching. As disclosed in the commonly-assigned U.S. Pat. No. 5,422,172 (“Wu '172”), which is incorporated by reference, laminates of the sort made here can be activated by incremental stretching using the intermeshing rollers described therein.

### Example 1

An elastomeric film of the present invention was prepared by cast extrusion. The elastomeric film comprised a polyolefinic elastomer (Vistamaxx® 6102, ExxonMobil) at a concentration of 60% of the formulation weight, a Bio-Sus polymer of polylactic acid (PLA) (IINGEO® 4043D, NatureWorks LLC) at a concentration of 25% of the formulation weight, and a compatibilizer of ethylene methacrylate (EMA) (Optema™ TC110, ExxonMobil) at a concentration of 15% of the formulation weight. The film had a basis weight of roughly 75 gsm.

### Example 2

An elastomeric film of the present invention was prepared by cast extrusion. The elastomeric film comprised a polyolefinic elastomer (Vistamaxx® 6102, ExxonMobil) at a concentration of 50% of the formulation weight, a Bio-Sus polymer of PLA (NGEO® 4043D, NatureWorks LLC) at a concentration of 35% of the formulation weight, and a compatibilizer of EMA (Optema™ TC110, ExxonMobil) at a concentration of 15% of the formulation weight. The film had a basis weight of roughly 75 gsm.

### Example 3

An elastomeric film of the present invention was prepared by cast extrusion. The elastomeric film comprised a polyolefinic elastomer (Vistamaxx® 6102, ExxonMobil) at a concentration of 45% of the formulation weight, a Bio-Sus polymer of PLA (NGEO® 4043D, NatureWorks LLC) at a concentration of 40% of the formulation weight, and a compatibilizer of EMA (Optema™ TC110, ExxonMobil) at a concentration of 15% of the formulation weight. The film had a basis weight of roughly 75 gsm.

### COMPARATIVE EXAMPLE 1

An elastomeric film of the present invention was prepared by cast extrusion. The elastomeric film comprised a polyolefinic elastomer (Vistamaxx® 6102, ExxonMobil) at a concentration of 35% of the formulation weight, a Bio-Sus polymer of PLA (NGEO® 4043D, NatureWorks LLC) at a concentration of 50% of the formulation weight, and a compatibilizer of EMA (Optema™ TC110, ExxonMobil) at a concentration of 15% of the formulation weight. The film had a basis weight of roughly 75 gsm.

The films made in Examples 1-3 and the Comparative Example 1 were easily extruded into good quality films. The films were analyzed by tensile testing to determine maximum strain at break and permanent set. FIGS. 1 and 2 show the maximum strain of each example in the machine direction (MD) and cross-direction (CD), respectively. Example 1 has a strain at break of about 525% in the MD, which is somewhat greater than the other example films. In the CD, Example 1 also has a strain at break of over 600% in the CD, which is dramatically greater than the other example films. Example 2 has an acceptable strain at break, over 300%, in the CD, while the Example 3 and the Comparative Example 1 both have CD strains at break less than 300%.

These films were also tested for permanent set after being stretched to 150% of their original length. The results are shown in Table 1.

TABLE 1

| | | | | CD Permanent | |
|---|---|---|---|---|---|
| | Vistamaxx | PLA | EMA | Set after | |
| Example | 6102 | 4043D | TC110 | 50% stretch | Film Note |
| 1 | 60% | 25% | 15% | 7.4% | good quality |
| 2 | 50% | 35% | 15% | 17.3% | good quality |
| 3 | 45% | 40% | 15% | 20.0% | good quality |
| Comp 1 | 35% | 50% | 15% | 31.4% | good quality |

Example 1 has a permanent set of 7.4% after being stretched to 150% of its original length. This is a very acceptable permanent set for elastomeric films in most applications. Examples 2 and 3 have permanent sets of 17.3 and 20.0%, respectively. These permanent set values are acceptable for elastomeric films in some applications. However, Comparative Example 1 has a permanent set greater than 30%, which is the characteristic of an extensible film rather than an elastomeric film.

Tensile Test

This method was used to determine the force versus engineering strain curve of the materials. The tensile test method is based on ASTM D882-02. Suitable instruments for this test include tensile testers available from MTS Systems Corp. (Eden Prairie, Minn.) or Instron Engineering Corp. (Canton, Mass.). For the test, test specimens of each material with dimensions of 25.4 mm wide by about 100 mm long were cut. The samples were conditioned for at least 1 hour at 23°±2° C. Each specimen was then mounted with the long axis substantially vertical in 1.00 inch wide grips, with a gap of 2.00 inches between the grip faces and no slack in the specimen. The specimen is then stretched by the testing machine at a crosshead speed of 20 inches per minute (50.8 cm/min) until the sample breaks. A minimum of three specimens are used to determine average test values.

The tensile test results are reported for each material as percent strain at break. The percent strain at break measures how long the laminate can stretch before it breaks. The ultimate tensile strength measures how much force must be exerted on the sample immediately before it breaks.

Two Cycle Hysteresis Test and Permanent Set

This method is used to determine the stretch-and-recovery properties of the elastomeric materials. The hysteresis test method is based on ASTM D882-02. Suitable instruments for this test include tensile testers available from MTS Systems Corp. (Eden Prairie, Minn.) or Instron Engineering Corp. (Canton, Mass.). For the test, test specimens of each material with dimensions of 25.4 mm wide by about 76.2 mm long were cut. The samples were conditioned for at least 1 hour at 23°±2° C. Each specimen was then mounted with the long axis substantially vertical in 1.00 inch wide grips, with a gap of 1.0 inches (25.4 mm) between the grip faces and no slack in the specimen. For the first cycle of the two-cycle hysteresis test method, the specimen is stretched by the testing machine at a crosshead speed of 20 inches per minute (50.8 cm/min) to the specified engineering strain (e.g. engineering strain=150%). Then the engineering strain is reduced to 0% by returning the grips to the original gauge length at a constant crosshair speed of 50.8 cm/min. The specimen is stretched for a second cycle by repeating the first cycle steps. A minimum of three specimens are used to determine average test values.

The two-cycle hysteresis test is used to measure the percent permanent set of the elastic material. The percent permanent set is defined as the % strain after the start of the second load cycle where a load force of 8 grams is measured.

The Examples and specific embodiments described herein are for illustrative purposes only and are not intended to be limiting of the invention defined by the following claims. Additional embodiments and examples within the scope of the claimed invention will be apparent to one of ordinary skill in the art.

This has been a description of the present invention along with the preferred method of practicing the present invention. However, the invention itself should only be defined by the appended claims, WHEREIN WE CLAIM:

1. An elastomeric film, comprising an elastomeric polymer and a biodegradable or sustainable (Bio-Sus) polymer, wherein the Bio-Sus polymer comprises about 5-40% of the elastomeric film composition.

2. The elastomeric film according to claim 1, wherein the Bio-Sus polymer comprises about 5-38% of the elastomeric film composition.

3. The elastomeric film according to claim 1, wherein the Bio-Sus polymer comprises about 5-35% of the elastomeric film composition.

4. The elastomeric film according to claim 1, wherein the Bio-Sus polymer comprises about 5-30% of the elastomeric film composition.

5. The elastomeric film according to claim 1, wherein the Bio-Sus polymer comprises about 5-25% of the elastomeric film composition.

6. The elastomeric film according to claim 1, wherein the Bio-Sus polymer is selected from the group consisting of polylactic acid, polycaprolactone, polyhydroxyalkanoates, polyhydroxybutyrates, polyhydroxyvalerates, thermoplastic starch, biodegradable polyesters, sustainable polyolefins, sustainable thermoplastic starch blends, sustainable polyesters, copolymers thereof, and blends thereof.

7. The elastomeric film according to claim 6, wherein the elastomeric film also comprises a compatibilizing polymer.

8. The elastomeric film according to claim 7, wherein the compatibilizing polymer is selected from the group consisting of polyesters, poly(alkyl methyl acrylates), poly (alkyl acrylates), polyvinyl acetate, polystyrene, copolymers thereof and blends thereof.

9. The elastomeric film according to claim 7, wherein the compatibilizing polymer comprises poly(ethylene methyl acrylate).

10. The elastomeric film according to claim 1, wherein the elastomeric film is laminated to another substrate layer.

11. The elastomeric film according to claim 10, wherein said substrate layer is a nonwoven fabric.

12. The elastomeric film according to claim 10, wherein the film is laminated to said substrate layer by extrusion lamination or by adhesive lamination.

13. The elastomer film claimed in claim 1 wherein said Bio-Sus polymer is an aliphatic polyester.

14. The elastomeric film claimed in claim 13 wherein said aliphatic polyester is polylactic acid.

15. The elastomeric film claimed in claim 1 wherein said Bio-Sus is a polyalkanoate.

16. The elastomeric film according to claim 1, wherein the elastomeric film has a strain at break in the CD of about 250% or greater.

17. The elastomeric film according to claim 16, wherein the elastomeric film has a strain at break in the CD of about 500% or greater.

18. The elastomeric film according to claim 16, wherein the elastomeric film has a strain at break in the CD of about 300% or greater.

19. The elastomeric film according to claim 1, wherein the elastomeric film has a basis weight of about 5 gsm to about 150 gsm.

20. The elastomeric film according to claim 1, wherein the elastomeric film has a basis weight of about 25 gsm to about 80 gsm.
